(19) United States
(12) Patent Application Publication
(10) Pub. No.: US 2017/0010804 A1
(43) Pub. Date: Jan. 12, 2017

(54) VEHICLE AND CONTROL METHOD FOR THE VEHICLE

(71) Applicant: HYUNDAI MOTOR COMPANY, Seoul (KR)

(72) Inventors: Jungsang MIN, Seoul (KR); Jeong-Eom LEE, Yongin-si (KR); Gi Beom HONG, Bucheon-si (KR); Sihyun JOO, Seoul (KR)

(21) Appl. No.: 14/945,183

(22) Filed: Nov. 18, 2015

(30) Foreign Application Priority Data
Jul. 10, 2015 (KR) 10-2015-0098073

(51) Int. Cl. G06F 3/0488; G06F 3/16; G06F 3/0484; G06F 3/0482; G06F 3/0485

(52) U.S. Cl. CPC G06F 3/04886; G06F 3/04883; G06F 3/0482; G06F 3/0485; G06F 3/04845; G06F 3/04847; G06F 3/165

(57) ABSTRACT

A vehicle includes a touch input device provided with a touch area to which a touch gesture is input, and a processor for dividing the touch area into a first area and a second area, performing a first function when the touch gesture is input to the first area, and performing a second function, which is different from the first function, when the touch gesture is input to the second area.

### CROSS-REFERENCE TO RELATED APPLICATION(S)

This application claims the benefit of priority to Korean Patent Application No. 10-2015-0098073, filed on Jul. 10, 2015 with the Korean Intellectual Property Office, the disclosure of which is incorporated herein by reference.

### TECHNICAL FIELD

Embodiments of the present disclosure relate to a vehicle capable of controlling a function through a touch input and a control method of the vehicle.

### BACKGROUND

For the enhancement of the convenience of passengers, a variety of convenience equipment may be provided in a vehicle. However, a manipulation load for manipulating the variety of convenience functions may increase with increased functionality. The increase of the manipulation load may cause a reduction of driver concentration, and thus the risk of an incident may increase.

In order to reduce the manipulation load of the driver, an improved touch interface may be provided in a vehicle. The driver may more intuitively control a variety of convenience functions through the touch interface provided in the vehicle.

### SUMMARY OF THE DISCLOSURE

Therefore, it is an aspect of the present disclosure to provide a vehicle capable of performing various functions according to an input position of a touch gesture, and a control method of the vehicle.

Additional aspects of the present disclosure will be set forth in part in the description which follows and, in part, will be obvious from the description, or may be learned by practice of the present disclosure.

In accordance with one aspect of the present disclosure, a vehicle includes a touch input device provided with a touch area to which a touch gesture is input and a processor configured to divide the touch area into a first area and a second area, configured to perform a first function when the touch gesture is input to the first area, and configured to perform a second function, which is different from the first function, when the touch gesture is input to the second area.

The processor may set an edge area of the touch area as the first area, and the center area of the touch area as the second area.

The touch area may be provided in a way that the center of the touch area is to be concave, and the processor may divide the touch area into the first area and the second area by setting a virtual boundary line with respect to the center of the touch area.

The touch area may include a first touch unit provided in an oval or circular shape, and a second touch unit provided to be along a cylindrical surface of the first touch unit, wherein the processor may set the second touch unit as the first area, and the first touch unit as the second area.

The vehicle may further include a display unit configured to display an tem list, wherein the processor may perform a first function scrolling an item list by a page unit when the touch gesture is input to the first area, and a second function scrolling an item list by an item unit when the touch gesture is input to the second area. At this time, the processor may determine the direction of scroll based on an input direction of the touch gesture, and may determine the size of scroll based on the size of the touch gesture.

The vehicle may further include a display unit configured to display a plurality of characters, wherein the processor may perform a first function, which is configured to select character while moving by consonant unit, when the touch gesture is input to the first area, and may perform a second function, which is configured to select character while moving by vowel unit, when the touch gesture is input to the second area. At this time, the display unit may display the plurality of characters to be arranged to correspond to the shape of the touch area.

The vehicle may further include a display unit configured to display a radio channel control screen, wherein the processor may perform a first function configured to change a frequency to correspond to the touch gesture, when the touch gesture is input to the first area, and may perform a second function configured to change a frequency by a pre-set frequency unit, when the touch gesture is input to the second area.

The vehicle may further include a display unit provided with a top menu display area configured to display a top menu, and a sub menu display area configured to display a sub menu corresponding to the top menu, wherein the processor may perform a first function configured to adjust the selection of the top menu, when the touch gesture is input to the first area, and may perform a second function configured to adjust the selection of the sub menu, when the touch gesture is input to the second area. At this time, the display unit may display a sub menu, which is changed according to the change in the selection of the top menu, displayed on the sub menu display area.

The vehicle may further include a display unit configured display a map, wherein the processor may perform a first function configured to change the scale according to a first reference, when the touch gesture is input to the first area, and may perform a second function configured to change the scale according to a second reference different from the first reference, when the touch gesture is input to the second area.

In accordance with another aspect of the present disclosure, a control method of a vehicle includes a receiving an input of touch gesture through a touch input device, determining an area to which the touch gesture is input, and performing a pre-set function according to an input area of the touch gesture.

The control method may further include dividing a touch area into the plurality of areas by setting a virtual boundary line in the touch input device. The virtual boundary line may be set with respect to the center of the touch area.

The control method may further include displaying an item list, wherein performing a pre-set function according to an input area may include determining a scroll unit of the item list according to the input area of touch gesture, and performing scrolling by the determined scroll unit.

The control method may further include displaying a plurality of characters, wherein performing a pre-set function according to the input area may include selecting characters by vowel unit when the input area of touch gesture is the center area, and selecting characters by consonant unit when the input area of touch gesture is the edge area.

The control method may further include displaying a radio channel control screen, wherein performing a pre-set function according to an input area may include changing a frequency to correspond to the touch gesture when the input area of touch gesture is the center area, and changing a frequency by a pre-set frequency unit when the input area of touch gesture is the edge area.

The control method may further include displaying a top menu and a sub menu corresponding to the top menu, wherein performing a pre-set function according to an input area may include adjusting the selection of the top menu when the input area of touch gesture is the edge area, and adjusting the selection of the sub menu when the input area of touch gesture is the center area. At this time, the performing a pre-set function according to an input area may further include displaying a sub menu, which is changed to correspond to the changed top menu, when the selection of the top menu is changed.

### BRIEF DESCRIPTION OF THE DRAWINGS

These and/or other aspects of the disclosure will become apparent and more readily appreciated from the following description of embodiments, taken in conjunction with the accompanying drawings of which:

FIG. 1 is a perspective view schematically illustrating an exterior of a vehicle in accordance with one embodiment of the present disclosure;

FIG. 2 is a perspective view schematically illustrating an interior of a vehicle in accordance with one embodiment of the present disclosure;

FIG. 3 is a perspective view schematically illustrating a touch input device in accordance with one embodiment of the present disclosure;

FIG. 4 is a plane view schematically illustrating a touch input device in accordance with one embodiment of the present disclosure;

FIG. 5 is a cross-sectional view taken along line A-A of a touch input device in accordance with one embodiment of the present disclosure;

FIG. 6 is a perspective view schematically illustrating a touch input device in accordance with another embodiment of the present disclosure;

FIG. 7 is a plane view schematically illustrating a touch input device in accordance with another embodiment of the present disclosure;

FIG. 8 is a cross-sectional view taken along line B-B of a touch input device in accordance with another embodiment of the present disclosure;

FIG. 9 is a view illustrating a modified example of a touch input device in accordance with another embodiment of the present disclosure;

FIG. 10 is a control block diagram illustrating an interaction of a vehicle in accordance with one embodiment of the present disclosure;

FIG. 11 is a view illustrating an example of a layout of a touch input device;

FIG. 12 is a view illustrating touch-gesture input to a first area;

FIG. 13 is a view illustrating touch-gesture input to a second area;

FIG. 14 is a view illustrating the variation of an English input screen by touching a first area;

FIG. 15 is a view illustrating the variation of an English input screen by touching a second area;

FIG. 16 is a view illustrating the variation of a Korean input screen by touching a first area;

FIG. 17 is a view illustrating the variation of a Korean input screen by touching a second area;

FIG. 18 is a view illustrating the variation of a content list screen by touching a first area;

FIG. 19 is a view illustrating the variation of a content list screen by touching a second area;

FIG. 20 is a view illustrating the variation of a radio control screen by touching a first area;

FIG. 21 is a view illustrating the variation of a radio control screen by touching a second area;

FIG. 22 is a view illustrating the variation of a menu selection screen by touching a first area;

FIG. 23 is a view illustrating the variation of a menu selection screen by touching on a second area;

FIG. 24 is a view illustrating the variation of a navigation screen by touching a first area;

FIG. 25 is a view illustrating the variation of a navigation screen by touching a second area;

FIG. 26 is a view illustrating another example of a layout of a touch input device;

FIG. 27 is a view illustrating another example of a layout of a touch input device, distinct from that of FIG. 26;

FIG. 28 is a view illustrating selecting a menu by using an input device of FIG. 27; and

FIG. 29 is a flowchart illustrating a control method of a vehicle 1 in accordance with one embodiment of the present disclosure.

### DETAILED DESCRIPTION

The present disclosure will now be described more fully with reference to the accompanying drawings, in which exemplary embodiments of the disclosure are shown. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art. In the description of the present disclosure, if it is determined that a detailed description of commonly-used technologies or structures related to the embodiments of the present disclosure may unnecessarily obscure the subject matter of the disclosure, the detailed description will be omitted.

Reference will now be made in detail to embodiments of the present disclosure, examples of which are illustrated in the accompanying drawings.

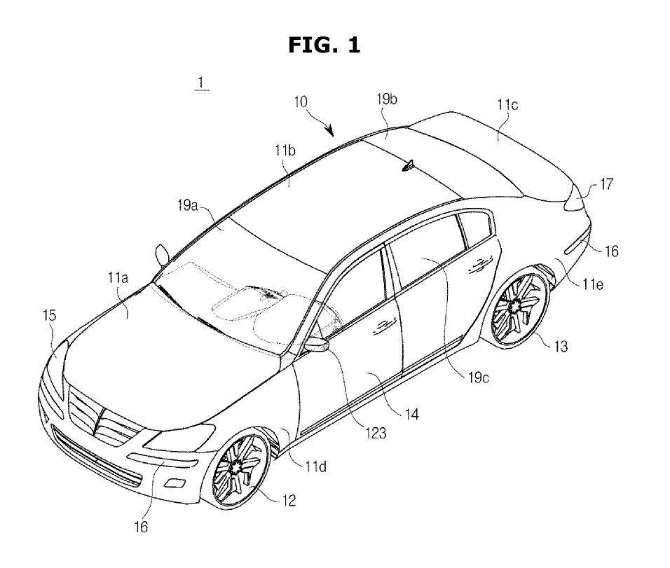

FIG. 1 is a perspective view schematically illustrating an exterior of a vehicle 1 in accordance with one embodiment of the present disclosure.

Referring to FIG. 1, the vehicle 1 may include a body 10 forming an exterior of the vehicle 1, and vehicle wheels 12 and 13 moving the vehicle 1.

The body 10 may include a hood 11a protecting a variety of devices, needed to drive the vehicle 1, e.g., an engine, a roof panel 11b forming an inner space, a trunk lid 11c provided with a storage space, a front fender 11d and a quarter panel 11e provided on the side of the vehicle 1. In addition, a plurality of doors 15 hinge-coupled to the body 10 may be provided on the side of the body 10.

Between the hood 11a and the roof panel 11b, a front window 19a may be provided to provide a view of a front side of the vehicle 1, and between the roof panel 11b and the trunk lid 11c, a rear window 19b may be provided to provide a view of a back side of the vehicle 1. In addition, on an upper side of the door 15, a side window 19c may be provided to provide a view of a lateral side.

On the front side of the vehicle 1, a headlamp 15 emitting a light in a driving direction of the vehicle 1 may be provided.

On the front and rear side of the vehicle 1, a turn signal lamp 16 indicating a driving direction of the vehicle 1 may be provided.

The vehicle 1 may display a driving direction thereof by flashing the turn single lamp 16. On the rear side of the vehicle 1, a tail lamp 17 may be provided. The tail lamp 17 may be provided on the rear side of the vehicle 1 to display gear transmission condition and a brake operation condition of the vehicle 1.

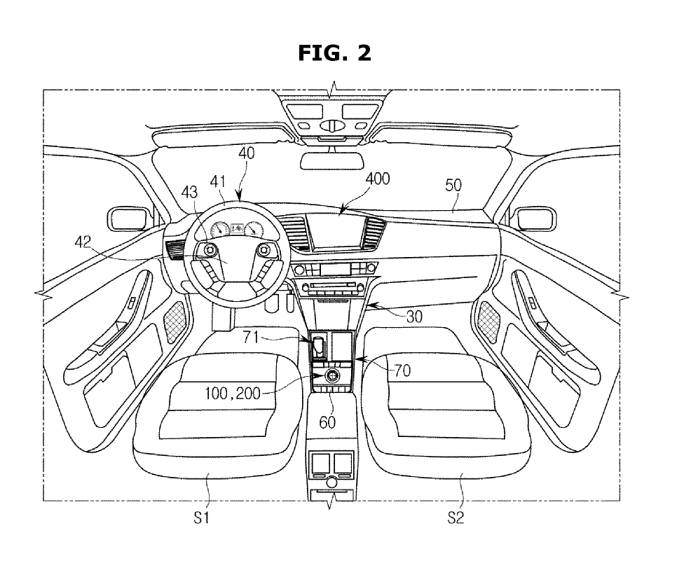

FIG. 2 is a perspective view schematically illustrating an interior of a vehicle 1 in accordance with one embodiment of the present disclosure.

Referring to FIG. 2, in the vehicle 1, a plurality of seats S1 and S2 may be provided so that passengers may sit in the vehicle 1. On the front side of the seats S1 and S2, a dashboard 50 may be disposed wherein a variety of gauges needed for driving are provided.

In the dashboard 50, a steering wheel 40 may be provided to control a driving direction of the vehicle 1. The steering wheel 40 may be a device for steering, and may include a rim which a driver holds, and a spoke 42 connecting the rim 41 to a rotational shaft for steering. As needed, the steering wheel 40 may further include a manipulation device 43 configured to operate convenience equipment.

The dashboard 50 may further include a gauge configured to transmit information related to a driving condition and operation of each component of the vehicle 1. The position of the gauge is not limited thereto, but may be provided on the rear side of the steering wheel 40 in consideration of a visibility of a driver.

The dashboard 50 may further include a display unit 400. The display unit 400 may be disposed in the center of the dashboard 50, but is not limited thereto. The display unit 400 may display information related to a variety of convenience equipment provided on the vehicle 1, as well as information related to driving the vehicle 1. The display unit 400 may display a user interface configured to allow a user to control the variety of convenience equipment of the vehicle 1. An interface displayed on the display unit 400 will be described later.

The display unit 400 may be implemented by Plasma Display Panel (PDP), Liquid Crystal Display (LCD) panel, Light Emitting Diode (LED) panel, Organic Light Emitting Diode (OLED) panel, or Active-matrix Organic Light-Emitting Diode (AMOLED) panel, but is not limited thereto.

The display unit 400 may be implemented by a Touch Screen Panel (TSP) further including a touch recognition device configured to recognize a user's touch. When the display unit 400 is implemented by the TSP, a user may control a variety of convenience equipment by touching the display unit 400.

In the center of the dashboard 50, a center fascia 30 may be provided to control a variety of devices provided on the vehicle 1.

A center console 70 may be provided between the center fascia 30 and an arm rest 60. In the center console 70, a gear device operating a gear of the vehicle 1, and touch input devices 100 and 200 controlling a variety of convenience equipment of the vehicle 1 may be provided. Hereinafter a description of touch input devices 100 and 200 will be described in detail.

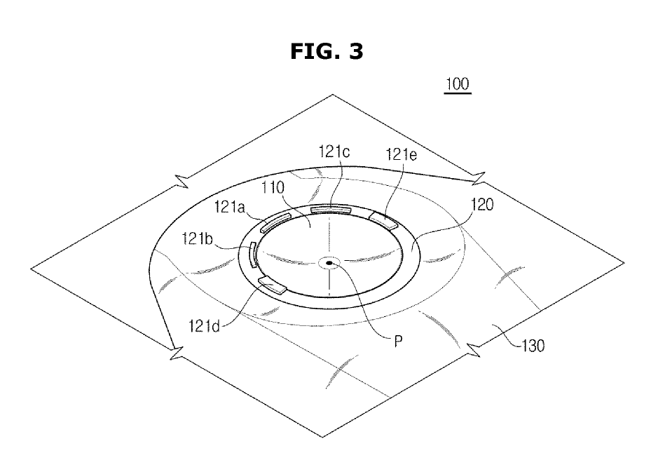

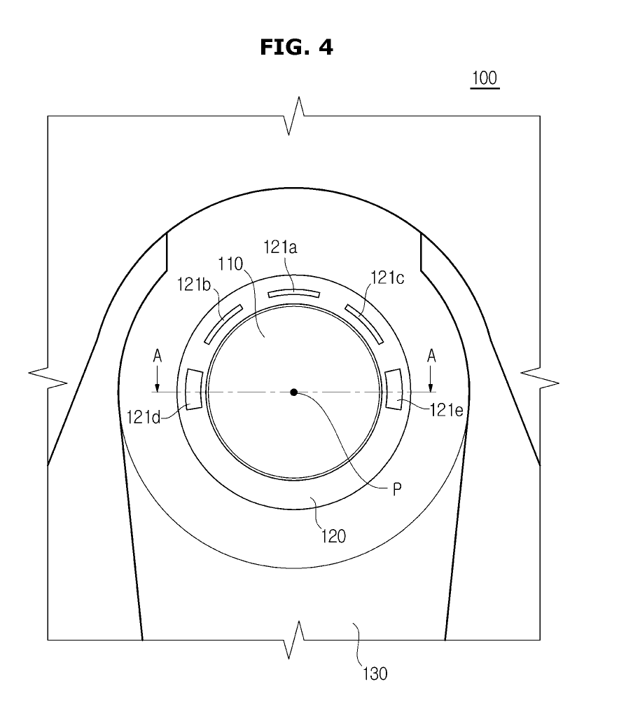

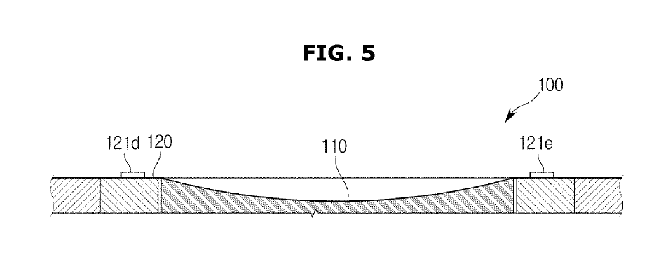

FIG. 3 is a perspective view schematically illustrating a touch input device in accordance with one embodiment of the present disclosure, FIG. 4 is a plane view schematically illustrating a touch input device in accordance with one embodiment of the present disclosure and FIG. 5 is a cross-sectional view taken along line A-A of a touch input device in accordance with one embodiment of the present disclosure.

Referring to FIGS. 3 to 5, the touch input device 100 may include a touch unit 110 provided with a touch area configured to detect a touch of a user, and an edge unit 120 surrounding the touch unit 110.

The touch unit 110 may receive an input of a touch gesture of a user, and the input touch gesture may output an electrical signal corresponding to the touch gesture. A user may input a touch gesture by using a finger or a touch pen.

To detect a touch gesture, the touch unit 110 may include a touch sensor configured to detect a touch and generate an electrical signal corresponding to the detected touch.

The touch sensor may recognize a touch of a user by using capacitive technology, resistive technology, infrared technology and surface acoustic wave technology, but is not limited thereto. Any of the techniques, which are well known previously or which will be developed in the future may be used.

The touch sensor may be provided in the type of touch pad, touch film, or touch sheet.

Meanwhile, the touch sensor may recognize “proximity touch” which is generated by being adjacent to the touch area without contacting on the touch area, as well as “contact touch” which is generated by directly contacting on the touch area.

The touch area of the touch unit 110 may be formed in a circular shape. When the touch unit 110 is provided in a circular shape, a concave surface may be easily formed. In addition, since the touch unit 110 is formed in a circular shape, a user may detect the touch area of the circular touch unit 110 by the tactility and thus a user may easily input a gesture.

The touch unit 110 may include a lower portion than the edge unit 120. That is, the touch area of the touch unit 110 may be provided to be inclined downward from a boundary line of the edge unit 120. Alternatively, the touch area of the touch unit 110 may be provided to have a step from the boundary line of the edge unit 120 to be placed in a lower position than the boundary line of the edge unit 120.

As mentioned above, since the touch area of the touch unit 110 includes a lower portion than the boundary line of the edge unit 120, a user may recognize the area and the boundary of the touch unit 110 by tactility. That is, the user may intuitively recognize the center and the edge of the touch unit 110 by the tactility, and thus the user may input a touch to an accurate position. Accordingly, the input accuracy of the touch gesture may be improved.

The touch area of the touch unit 110 may have a concave surface. Concave may represent a dent or a recessed shape, and may include a dent shape to be inclined or to have a step as well as a dent shape to be circle, as illustrated in FIG. 5. At this time, in the touch area, the most concaved area may be set to be the center (P) of the touch area.

The curvature of the curbed surface of the touch unit 110 may vary according to a portion of the touch unit 110. For example, the curvature of the center may be small, that is the radius of curvature of the center may be large, and the curvature of the edge may be large, that is the radius of curvature of the edge may be small.

As mentioned above, since the touch unit 110 may have a curved surface, a user may intuitively recognize at which position of the touch unit 110 a finger is placed. The touch unit 110 may have a curved surface so that an inclination may vary according to a portion of the touch unit 110. Therefore, the user may intuitively recognize at which position of the touch unit 110 the finger is placed through a sense of inclination, which is felt through the finger. Accordingly, when the user inputs a gesture to the touch unit 110 in a state in which the user stares at a point besides the touch unit 110, a feedback related to a position where the finger is placed, may be provided to help the user to input a needed gesture, and may improve the input accuracy of a gesture.

The touch unit 110 may include a curved surface, and thus when inputting a touch, a sense of touch or a sense of operation, which is felt by the user, may be improved. The curved surface of the touch unit 110 may be provided to be similar with a trajectory which is made by a movement of the end of the finger when a person moves the finger or rotates or twists a wrist with stretching the finger, in a state in which a person fixes her/his wrist.

The edge unit 120 may represent a portion surrounding the touch unit 110, and may be provided by a member, which is separated from the touch unit 110. In the edge unit 120, touch buttons 121a to 121e configured to input a control command may be provided. A control command may be set in a plurality of touch buttons 121a to 121e in advance. For example, a first button 121a may be configured to move to a home, a fifth button 121e may be configured to move to a previous screen, and a second button to a fourth button 121b to 121d may be configured to operate pre-set functions.

As a result, the user may input a control command by touching the touch unit 110, and may input a control command by using the button 121 provided in the edge unit 120.

The touch input device 100 may further include a wrist supporting member 130 supporting a user's wrist. At this time, the wrist supporting member 130 may be disposed to be higher than the touch unit 110. This is to prevent a wrist from being bent when the user touches the touch unit 110 in a state of being supported by the wrist supporting member 130. Accordingly, while preventing user's musculoskeletal disease, a more comfortable sense of operation may be provided.

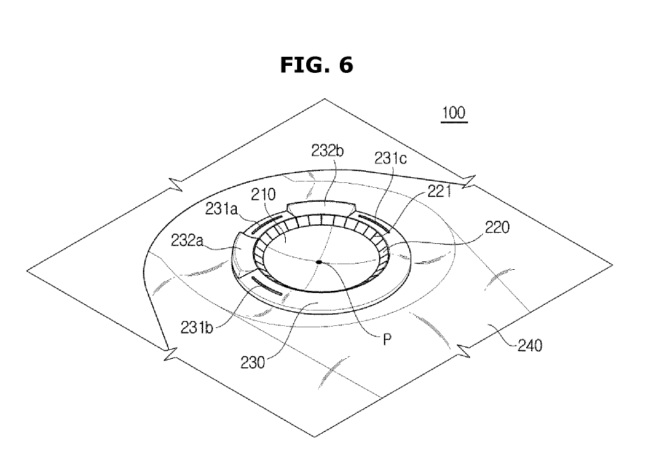

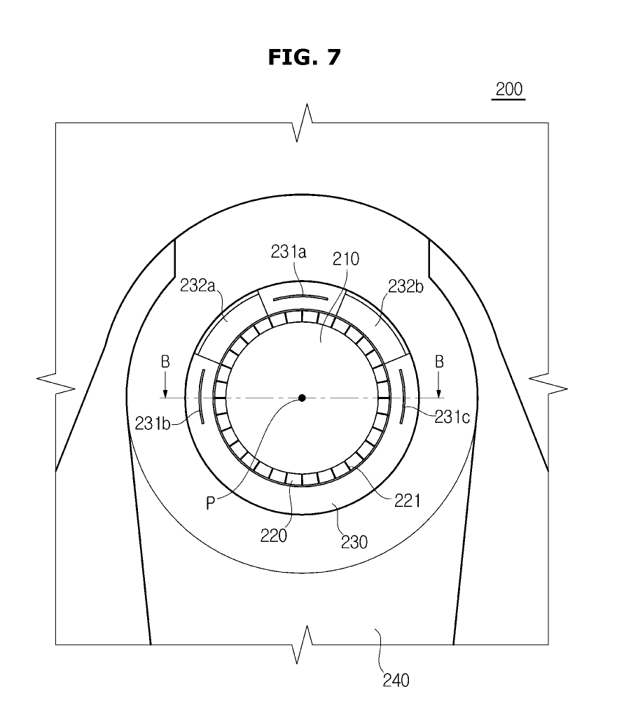

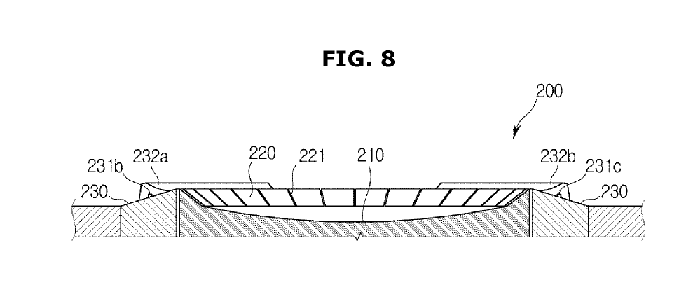

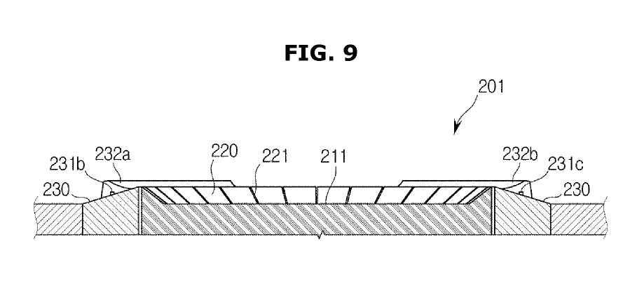

FIG. 6 is a perspective view schematically illustrating a touch input device in accordance with another embodiment of the present disclosure, FIG. 7 is a plane view schematically illustrating a touch input device in accordance with another embodiment of the present disclosure. FIG. 8 is a cross-sectional view taken along line B-B of a touch input device in accordance with another embodiment of the present disclosure and FIG. 9 is a view illustrating a modified example of a touch input device in accordance with another embodiment of the present disclosure.

Referring to FIGS. 6 to 8, the touch input device 200 according to another embodiment may include touch units 210 and 220 forming a touch area, and an edge unit 230 surrounding the touch units 210 and 220. Hereinafter the touch units 210 and 220 may have the same structure and configuration as that of the touch area 110 of the touch unit 100 according to one embodiment and thus an additional description is not described.

The touch units 210 and 220 may include a first touch unit 210 and a second touch unit 220 provided to be along an edge of the touch unit 210. A diameter of an area, which is a touch area, formed by the first touch unit 210 and the second touch unit 220 of the touch unit 210 and 220 may be formed in an ergonomic manner.

For example, given the average length of a finger of an adult, a range of the finger, which is made by the natural movement of the finger at a time in a state of fixing a wrist, may be selected within approximately 80 mm. Therefore, when a diameter of the touch units 210 and 220 is larger than 80 mm and when a user draws a circle in the second touch unit 220, a hand may be unnaturally moved and a wrist may be excessively manipulated. Conversely, when a diameter of the touch units 210 and 220 is less than 50 mm, an area of the touch area may be reduced and thus a diversity of possible input gestures may be reduced. In addition, the gesture may be made in a narrow area and thus gesture input errors may be increased.

Accordingly, the diameter of the touch unit 210 and 220 may be selected from approximately 50 mm to approximately 80 mm.

A shape of the second touch unit 220 may be determined depending on a shape of the first touch unit 210. For example, when the first touch unit 210 is provided in a circular shape, the second touch unit 220 may be provided in a ring shape between the first touch unit 210 and the edge unit 230.

A user may input a swiping gesture along the second touch unit 220. The second touch unit 220 may be provided along a circumference of the first touch unit 210, and thus the swiping gesture of the user may be recognized as a rolling gesture, which is drawing a circular arc with respect to the center (P) of the first touch unit 210, or a circling gesture, which is drawing a circle with respect to the center (P) of the second touch unit 220.

The second touch unit 220 may include a gradation 221. The gradation 221 may be provided to be engraved or embossed along the second touch unit 220 to provide a tactile feedback to a user. That is, the user may recognize a distance, which is touched, by the tactile feedback through the gradation 221. In addition, an interface displayed on the display unit 400 may be converted into a gradation unit. For example, according to the number of touched gradations, a cursor displayed on the display unit 400 may be moved, or a selected character may be changed.

The touch units 210 and 220 may be provided in a concave shape. A degree of concavity that is a degree of bend, of the touch unit 210 and 220 may be defined as a value acquired by dividing a depth of the touch unit 210 and 220 by a diameter.

Particularly, when a value acquired by dividing a depth of the touch units 210 and 220 by a diameter is larger than approximately 0.1, the curvature of the concave shape may be large and thus an excessive strong force may be applied to the finger when a user moves the finger along the curved surface. Accordingly, the user may feel an artificial sense of operation and thus a sense of touch of the user may become uncomfortable. Conversely, when a value, acquired by dividing a depth of the touch unit 210 and 220 by a diameter is less than approximately 0.04, a user may hardly feel a difference in a sense of operation between drawing a gesture on the curved surface and drawing a gesture on a plane surface. Therefore, the value acquired by dividing a depth of the touch units 210 and 220 by a diameter may be selected from approximately 0.04 to approximately 0.1 to be identical to the curvature of a curved line, which is drawn by the end of the finger in the natural movement of the user's finger.

The inclination of the second touch unit 220 may be provided to be different from that of the first touch unit 210. For example, the second touch unit 220 may be provided to have larger inclination than the first touch unit 210. As mentioned above, since the inclination of the second touch unit 220 and the inclination of the first touch unit 210 may be different from each other, the user may intuitively recognize the first touch unit 210 and the second touch unit 220.

The first touch unit 210 and the second touch unit 220 may be integrally formed, or may be formed in a separate manner. The first touch unit 210 and the second touch unit 220 may be implemented by a single touch sensor or by a separate sensor. When the first touch unit 210 and the second touch unit 220 are implemented by a single touch sensor, a touch in the first touch unit 210 and a touch in the second touch unit 220 may be distinguished according to coordinates in which a touch is generated.

The edge unit 230 may represent a portion surrounding the touch units 210 and 220, and may be provided by a separate member from the touch units 210 and 220. A key button 232a and 232b, or a touch button 231a, 231b and 231c surrounding the touch units 210 and 220 may be disposed in the edge unit 230. That is, the user may input a gesture from the touch units 210 and 220 or may input a signal by using the button 231 and 232 disposed on the edge unit 230 around the touch units 210 and 220.

The touch input device 200 may further include a wrist supporting member 240 disposed on a lower portion of a gesture input device to support a user's wrist.

FIG. 8 illustrates that the first touch unit 210 has a certain curvature, but the first ouch unit 210 may have a plane surface, as illustrate in FIG. 9.

Hereinafter for description convenience, an interaction of a vehicle will be described with reference to the touch input device 200 according to another embodiment.

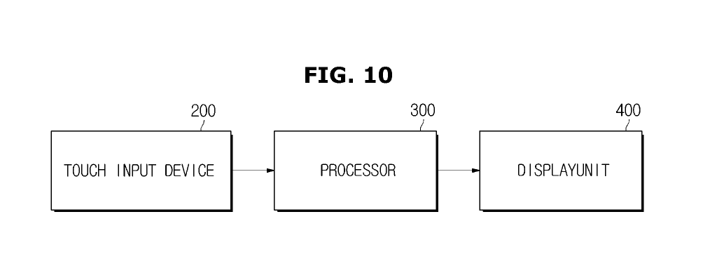

FIG. 10 is a control block diagram illustrating an interaction of a vehicle in accordance with one embodiment of the present disclosure.

Referring to FIG. 10, a vehicle 1 may include a touch input unit 200, a display unit 400 and a processor 300 providing and/or enabling an interaction. The processor 300 may recognize a touch gesture, which is input by a user, based on a control signal outputted from the touch input device 200. The processor 300 may control a screen displayed on the display unit 400 according to a recognized touch gesture.

At this time, the processor 300 may be implemented by a plurality of logic gate arrays, and may include a memory in which a program operated in the processor 300 is stored. The processor 300 may be implemented by a general purpose device, such as CPU or GPU, but is not limited thereto.

The processor 300 may control the display unit 400 so that a user interface, which is needed to operate convenience equipment of the vehicle 1, e.g., radio device, music device, navigation device, may be displayed.

At this time, the user interface displayed on the display unit 400, may include at least one item. Herein the item may represent an object selected by the user. For example, the item may include characters, menus, frequencies, and maps. In addition, each item may be displayed as an icon type, but is not limited thereto.

The processor 300 may recognize a touch gesture inputted through the touch input device 200 and may perform a command corresponding to the recognized touch gesture. Accordingly, the processor 300 may change a user interface displayed on the display unit 400 in response to the recognized touch gesture. For example, the processor 300 may recognize a multi gesture, e.g., pinch-in, and pinch-out, using a number of fingers as well as a single gesture, e.g., flicking, swiping and tap, using a single finger. Herein, flicking or swiping may represent an input performed in a way of moving touch coordinates in a direction and in a touch state, and then releasing the touch, tap may represent an input performed by tapping, pinch-in may represent an input performed by bringing fingers together, and pinch-out may represent an input performed by stretching touched fingers.

As mentioned above, the touch input device 200 may have a concave touch area so that the user may more correctly recognize a touch position. Performed functions may vary according to an input position of a touch gesture so that convenience in the operation may be enhanced.

The processor 300 may set a virtual layout on the touch input device 200, and different functions may be performed according to a position where a touch gesture is input. That is, although the same touch gesture is input, performed function may vary according to a position where the touch gesture is input. Hereinafter a virtual layout set by the processor 300 will be described in detail.

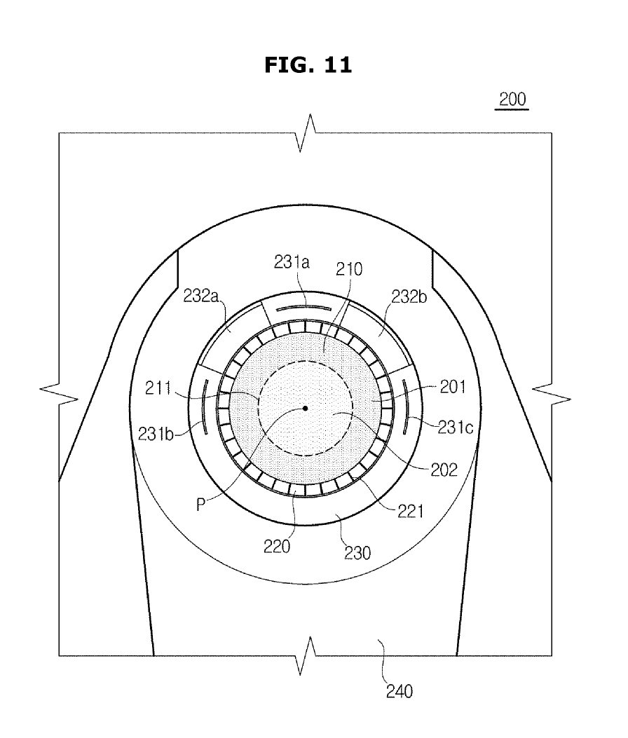

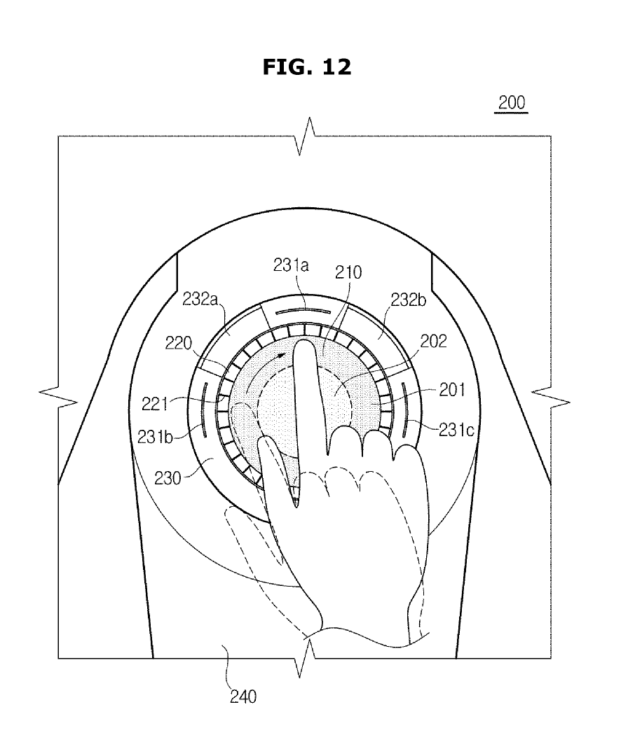

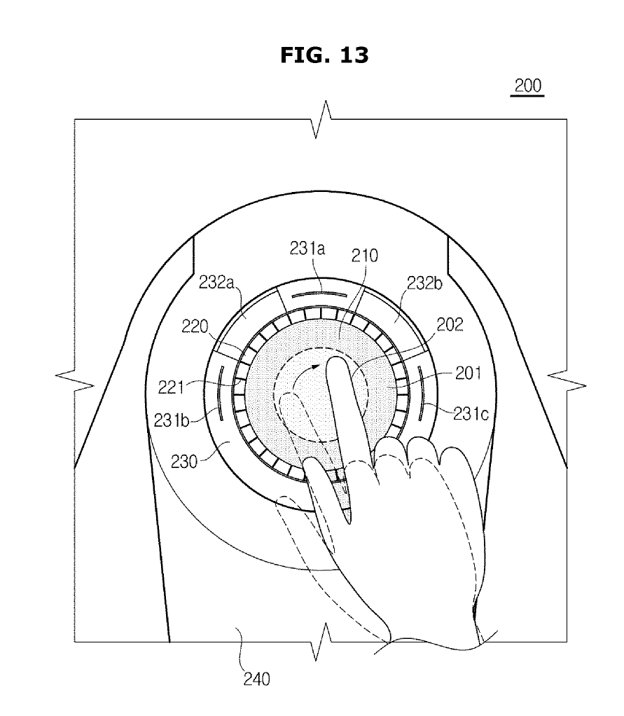

FIG. 11 is a view illustrating an example of a layout of a touch input device, FIG. 12 is a view illustrating touch-gesture input to a first area, and FIG. 13 is a view illustrating touch-gesture input to a second area.

Referring to FIG. 11, the first touch unit 210 may be divided into a first area 201 and a second area 202. That is, the processor 300 may divide the first touch unit 210 into two areas by setting a boundary line 211 in the first touch unit 210.

At this time, as the boundary line 211 is a virtual line, the boundary line 211 may be set to divide the first touch unit 210 into two areas. The boundary line 211 may be set with respect to the center (P) of the touch area. That is, the boundary line 211 may be set to have a certain distance from the center (P) of the first touch unit 210, and the first touch unit 210 may be divided into the first area 201 placed in an edge of the first touch unit 210 and the second area 202 placed in the center of the first touch unit 210 by the boundary line 211.

The processor 300 may determine that a touch gesture is input to the second area 202 when coordinates where a touch gesture is input are inside the boundary line 211, and may determine that a touch gesture is input to the first area 201 when coordinates where a touch gesture is input are outside the boundary line 211.

The processor 300 may perform a pre-set function according to an input position of touch gesture. As illustrated in FIG. 12, when a swiping gesture drawing a circular arc is input to the first area 201, a first function may be performed, and as illustrated in FIG. 13, when a swiping gesture drawing a circular arc in the second area 202 is input, a second function may be performed. Hereinafter the swiping gesture may be referred to as wheeling gesture or rolling gesture.

The first function and the second function may vary according to a user interface displayed on the display unit 400.

According to one embodiment, when a user interface for selecting characters of the display unit 400 is displayed, the processor 300 may allow the selection of characters to be varied according to an input position of touch gesture. Hereinafter description thereof will be described in detail.

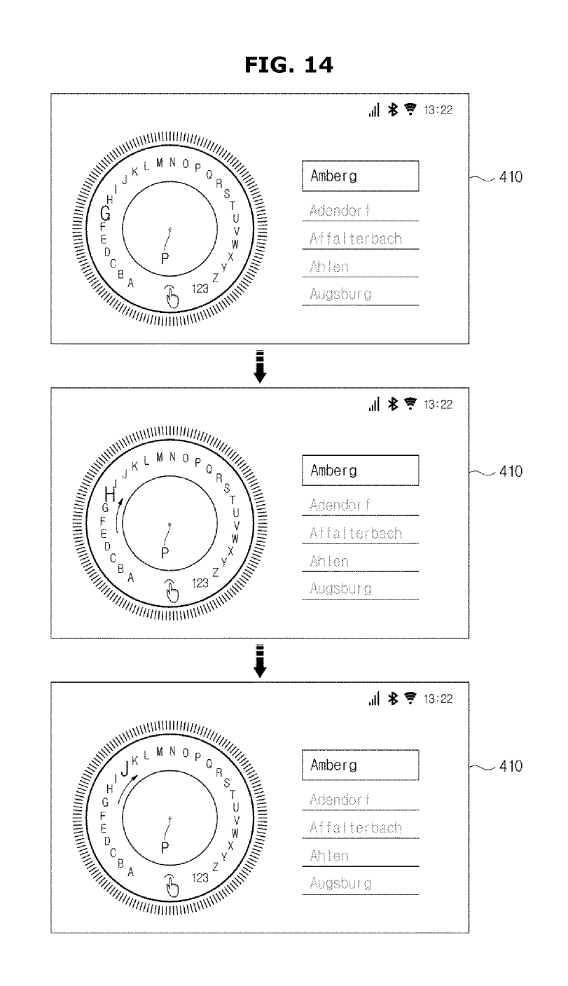

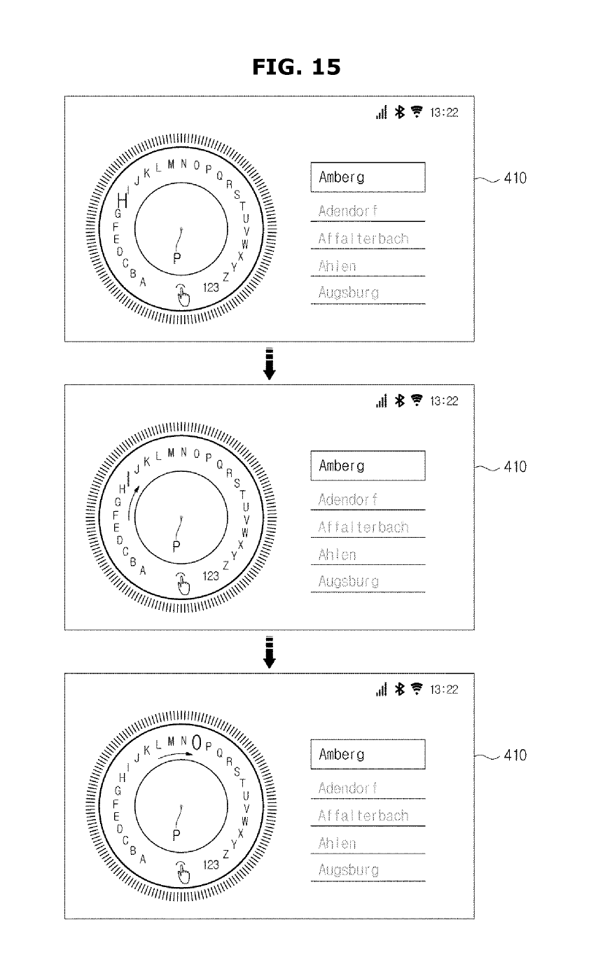

FIG. 14 is a view illustrating the variation of an English input screen by touching a first area, and FIG. 15 is a view illustrating the variation of English input screen by touching a second area. Each screen of FIGS. 14 and 15 illustrates an English input screen 410, and in FIGS. 14 and 15, each English character may correspond to above-mentioned item.

Referring to FIGS. 14 and 15, the display unit 400 may display a plurality of English characters capable of being input. An English character selected from the plurality of English characters may be displayed to be bigger and darker than other English characters. The plurality of English characters may be arranged to be circular to correspond to the shape of the touch area, but English characters arrangement method is not limited thereto.

A user may select a single English character among the plurality of English characters by inputting a touch gesture, and may input a morpheme having a certain meaning by repeatedly performing a process of inputting a selected English character. For example, a user may select an English character by inputting a rolling gesture acquired by drawing a circular arc in the touch area. At this time, an English character may be selected by a reference, which is different from others according to an area where a rolling gesture is input.

Referring to FIG. 14, when a rolling gesture is input to the first area 201, the processor 300 may select only consonants among the plurality of English characters. At this time, the selected consonant may be determined by an input direction of rolling gesture and an input size of rolling gesture. Herein, the input direction may be defined as a direction of a performed touch gesture, and the input size may be defined as a touch distance of a performed touch gesture or a touch angle of a performed touch with respect to the center (P) of the touch area.

Particularly, the processor 300 may move a selected consonant one by one whenever the input size of a rolling gesture input to the first area 201 is larger than a pre-determined reference size. For example, when a reference size is set to 3°, an English character may be selected by being moved one by one of a consonant unit whenever the input angle of rolling gesture is changed by 3°.

At this time, a moving direction of consonant may correspond to an input direction of rolling gesture.

That is, as illustrated in FIG. 12, when a rolling gesture is input clockwise, the processor 300 may select a consonant by a G->H->J order while moving clockwise whenever the input size of a rolling gesture is larger than a reference size. That is, a consonant I may be not selected, and thus J may be selected after H.

Conversely, when a rolling gesture is input to the second area 202, as illustrated in FIG. 15, vowels may be selected among the plurality of English characters. That is, when a rolling gesture is input clockwise, the processor 300 may select a vowel by A->E->I->O->U order while moving clockwise whenever the input size of a rolling gesture is larger than a reference size. That is, when a rolling gesture is input to the second area 202, only vowels I and O may be selected in order, particularly G after F may be not selected but I after F, and O after I may be selected in order.

The selected English character may be automatically input. According to one embodiment, an English character, which is selected at the time of completion of the rolling gesture by the user, may be automatically input. For example, as illustrated in FIG. 14, in a state in which J is selected, when stopping an input of a rolling gesture, that is termination of input, J may be automatically input.

In addition, the selected English character may be input by a creation gesture. For example, the selected English character may be input when a user inputs a tap gesture or a multi-tap gesture, or when a user inputs a swiping gesture toward the center (P) of the second touch unit 220.

FIGS. 14 and 15 illustrate that when a rolling gesture is input to the first area 201, an English character may be input by a consonant unit, and when a rolling gesture is input to the second area 202, an English character may be input by a vowel unit, but the selection reference of English character is not limited thereto.

For example, when a rolling gesture is input to the first area 201, an English character may be moved one by one regardless of consonant and vowel, and when a rolling gesture is input to the second area 202, an English character may be selected by vowel unit.

Alternatively, when a rolling gesture is input to the first area 201, an English character may be input by a vowel unit and when a rolling gesture is input to the second area 202, an English character may be input by a consonant unit.

As mentioned above, the selection reference of an English character may vary according to an input position of gesture, and thus a user may more easily input English characters.

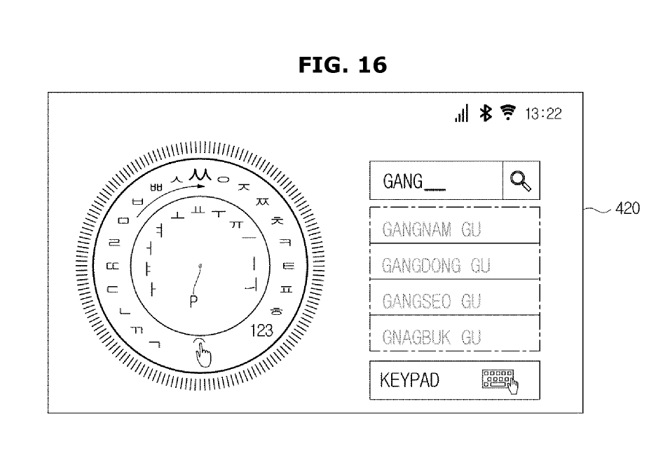

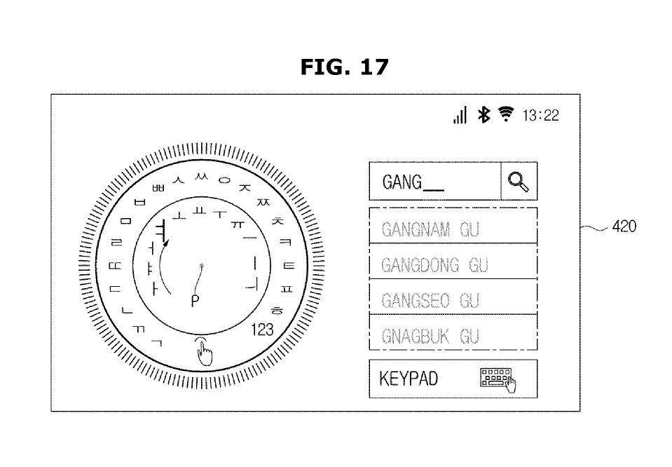

FIG. 16 is a view illustrating the variation of a Korean input screen by touching a first area, and FIG. 17 is a view illustrating the variation of a Korean input screen by touching a second area. Each screen of FIGS. 16 and 17 illustrate a Korean input screen 420, and in FIGS. 16 and 17, each Korean character may correspond to an above-mentioned item.

Referring to FIGS. 16 and 17, the display unit 400 may display Korean characters capable of being input. Korean characters may be arranged to be circular to correspond to the shape of the touch units 210 and 220. At this time, as Korean characters are classified into consonants and vowels, Korean characters may be displayed to be classified into consonants and vowels. For example, the number of vowels may be relatively less, and thus the vowels may be arranged along an inner side of a circle. The number of consonants may be relatively large, and thus the consonants may be arranged along an outside of a circle.

A user may select a single Korean character among the plurality of Korean characters by inputting a touch gesture, and may input a morpheme having a certain meaning by repeatedly performing a process of inputting a selected Korean character. At this time, the selection of Korean character may be performed by the rolling gesture in the same manner as the selection of an English character. As mentioned above, a finally selected Korean character may be determined according to the input size and the input direction of rolling gesture.

According to one embodiment, when a rolling gesture is input to the first area 201, the processor 300 may select one of the consonants, as illustrated in FIG. 16, and when a rolling gesture is input to the second area 202, the processor 300 may select one of the vowels, as illustrated in FIG. 17.

Particularly, when a rolling gesture is input to the first area 201, as illustrated in FIG. 12, the processor 300 may move a selected consonant one by one clockwise whenever the input size of rolling gesture is larger than a pre-determined reference size, as illustrated in FIG. 16. Herein, the reference size may be the same as the size set regarding an English character, but is not limited thereto.

When a rolling gesture is input to the second area 202, as illustrated in FIG. 13, the processor 300 may move a selected vowel clockwise whenever the input size of rolling gesture is larger than a pre-determined reference size, as illustrated in FIG. 17.

The selected consonant and vowel may be automatically input when a rolling gesture is completed, or may be input by a certain gesture by a user.

FIGS. 16 and 17 illustrate that consonants and vowels form a circle, respectively, but the arrangement of the consonants and the vowels is not limited thereto. For example, the consonants and the vowels may be formed in a single circle, or the consonants may be formed at outer circumferential surface and the vowels may be formed at inner circumferential surface.

As mentioned above, the selection reference of the consonants and the vowels may vary according to an input position of gesture, and thus a user may more easily input Korean characters.

According to another embodiment, the processor may vary a scroll method of items displayed according to the input position of touch gesture. Hereinafter, a description thereof will be described in detail.

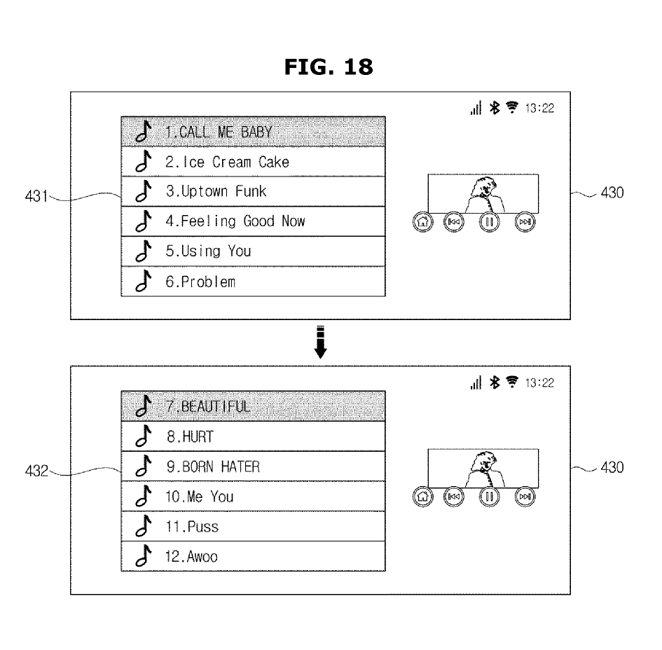

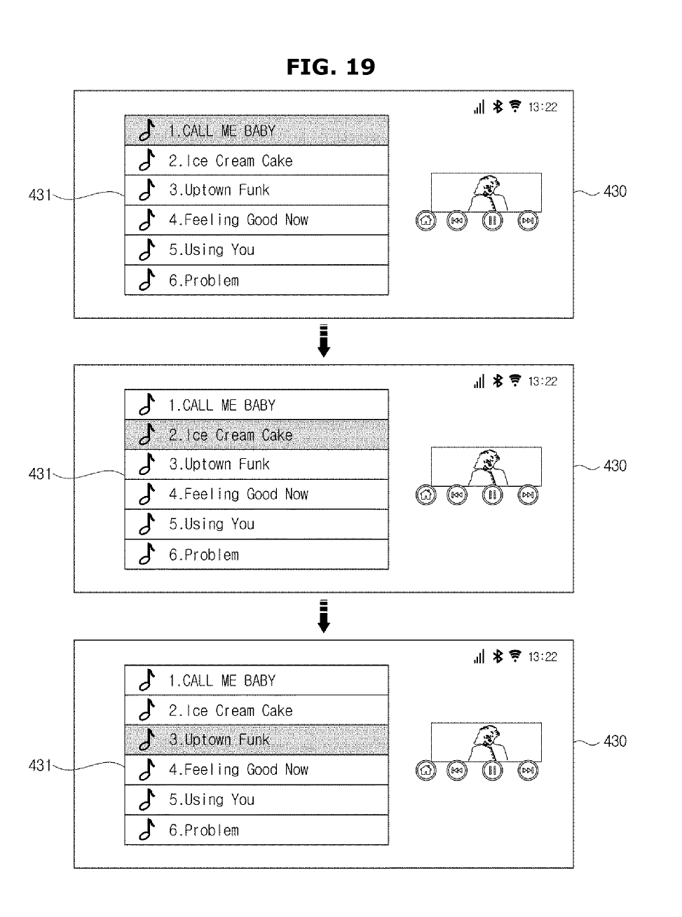

FIG. 18 is a view illustrating the variation of a content list screen by touching a first area and FIG. 19 is a view illustrating the variation of a content list screen by touching a second area. A screen of FIGS. 18 and 19 illustrates a content list screen 430, and in FIGS. 18 and 19, each content unit may correspond to an above-mentioned item.

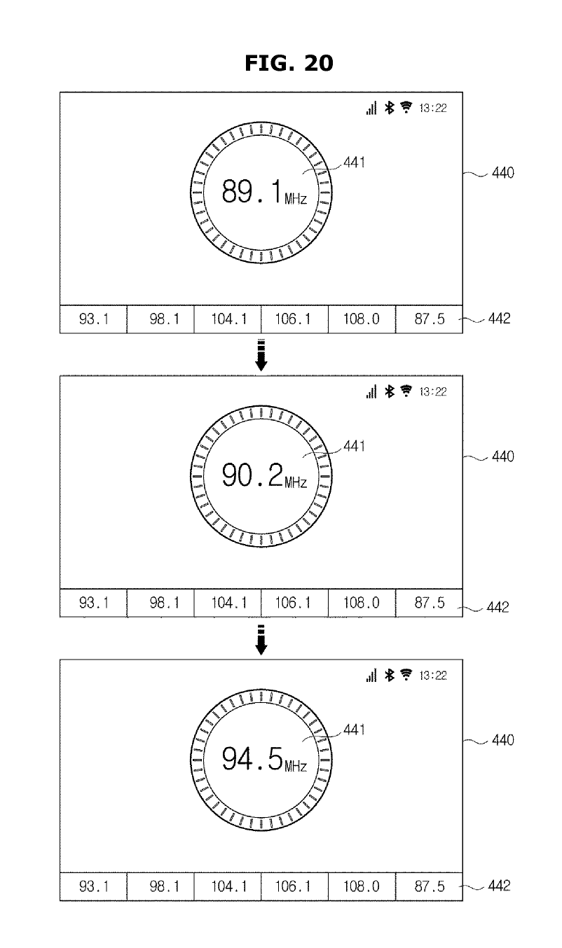

Referring to FIGS. 19 and 20, the processor 300 may search content selected by a user, and may generate a content list using searched content. The generated content list may be displayed on the display unit 400.

Since the size of the display unit 400 may be limited, a content list may be displayed and divided into pages. At this time, the number of content units forming a single page may be determined by the size of the display unit 400. For example, a single page may be formed by six content units.

In the content list, a selected content unit may be differently displayed from another content unit. For example, the background of the selected content may be displayed differently from the background of another content.

The processor 300 may scroll a content list in response to a touch gesture input by a user.

As illustrated in FIG. 12, when a rolling gesture is input to the first area 201, a content list may be scrolled by page, as illustrated in FIG. 18. At this time, a page may be moved and displayed whenever an input size of a rolling gesture is larger than a pre-set reference size. Particularly, the page may be moved and displayed whenever the input size of a rolling gesture is larger than a pre-determined reference size.

At this time, a page to be moved and displayed may be determined by the input direction of a rolling gesture. For example, when a rolling gesture is input clockwise as illustrated in FIG. 12, a next page 432 of displayed page 431 may be displayed, and when a rolling gesture is input counterclockwise, a previous page of displayed page may be displayed.

As illustrated in FIG. 13, when a rolling gesture is input to the second area 202, a content list may be scrolled by content, as illustrated in FIG. 19. At this time, a selected content may be determined by the input direction and the input size of the rolling gesture. Particularly, the selected content may be changed whenever the input size of rolling gesture is larger than a pre-set reference size.

At this time, the selected content may be determined by the input direction of rolling gesture. For example, when a rolling gesture is input clockwise as illustrated in FIG. 13, a next content of present selected content may be selected, and when a rolling gesture is input counterclockwise, a previous content of present selected content may be displayed. That is, when a user input a rolling gesture, as illustrate in FIG. 13, content may be scrolled by “CALL ME BABY”->“Ice Cream Cake”->“Uptown Funk” in order.

In other words, a user may search a content list by page unit by inputting a rolling gesture to the first area 201, and a user may search a content list by content unit by inputting a rolling gesture to the second area 202.

As mentioned above, a scroll method of content may vary according the input position of rolling gesture, and thus the convenience of the content search of the user may be improved.

The content selected through scrolling may be provided through a speaker or the display unit 400 provided in the vehicle 1. The processor 300 may automatically play the selected content when a pre-set period of time is expired after the content is selected. Alternatively, the processor 300 may play the selected content when a user inputs a certain gesture.

According to another embodiment, the processor 300 may vary a searching method of radio channels according to an input position of touch gesture.

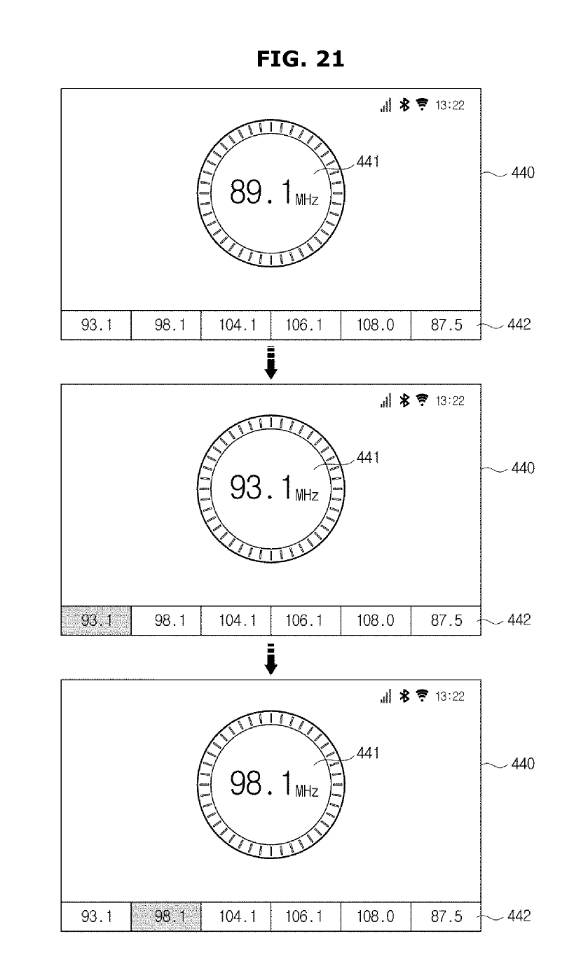

FIG. 20 is a view illustrating the variation of a radio control screen by touching a first area and FIG. 21 is a view illustrating the variation of a radio control screen by touching a second area. FIGS. 20 and 21 illustrate a control screen 440 to adjust a radio channel, and in FIGS. 20 and 21, a radio frequency may correspond to an above-mentioned item.

Referring to FIGS. 20 and 21, the radio control screen 440 displayed on the display unit 400 may include a frequency display area 441 displaying a present radio frequency, and a pre-set display area 442 displaying a pre-set frequency. Herein the pre-set frequency may represent a frequency which is stored in advance.

The processor 300 may adjust a radio channel by changing a radio frequency in response to a touch gesture input by a user.

As illustrated in FIG. 12, when a rolling gesture is input to the first area 201, a radio frequency may be moved to correspond to the rolling gesture, as illustrated in FIG. 20. At this time, the radio frequency may be moved according to the input direction and the input size of the rolling gesture. Particularly, the range of the increase and the range of the reduction of the radio frequency may be determined by the input direction of the rolling gesture. For example, as illustrated in FIG. 12, when a rolling gesture is input clockwise the radio frequency may be increased, and when a rolling gesture is input counterclockwise, the radio frequency may be reduced. At this time, the variety of increase and reduction of radio frequency may be determined to correspond to the input size of the rolling gesture.

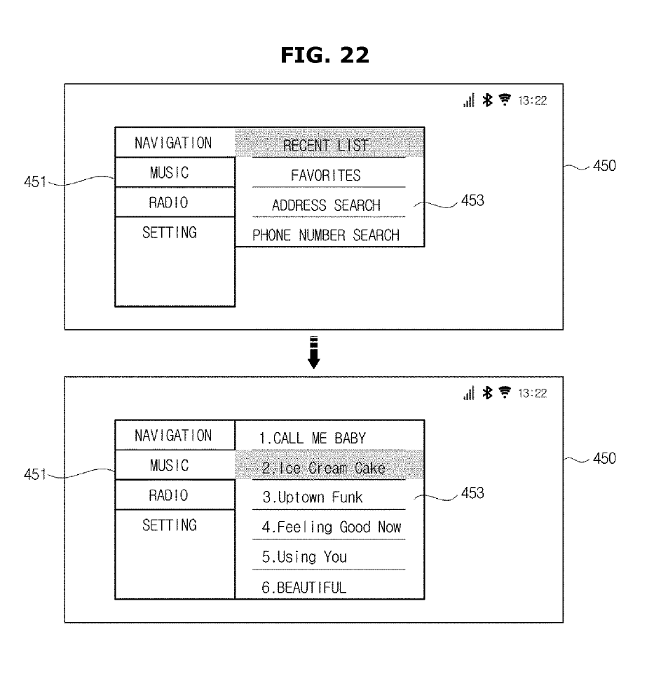

Meanwhile, as illustrated in FIG. 13, when a rolling gesture is input to the second area 202, the radio frequency may be moved by a pre-set frequency unit, as illustrated in FIG. 22. Particularly, when a rolling gesture is input clockwise as illustrated in FIG. 13, the radio frequency may be moved by a pre-set frequency that is moved from 93.1 to 97.3 in order. At this time, the selected pre-set frequency may be displayed to be clearer than other pre-set frequencies.

As mentioned above, a moving method of radio frequency may vary according the input position of a rolling gesture, and thus the convenience of the radio channel search of the user may be improved.

According to another embodiment, the processor 300 may vary a method of selecting a menu according to the input position of a touch gesture.

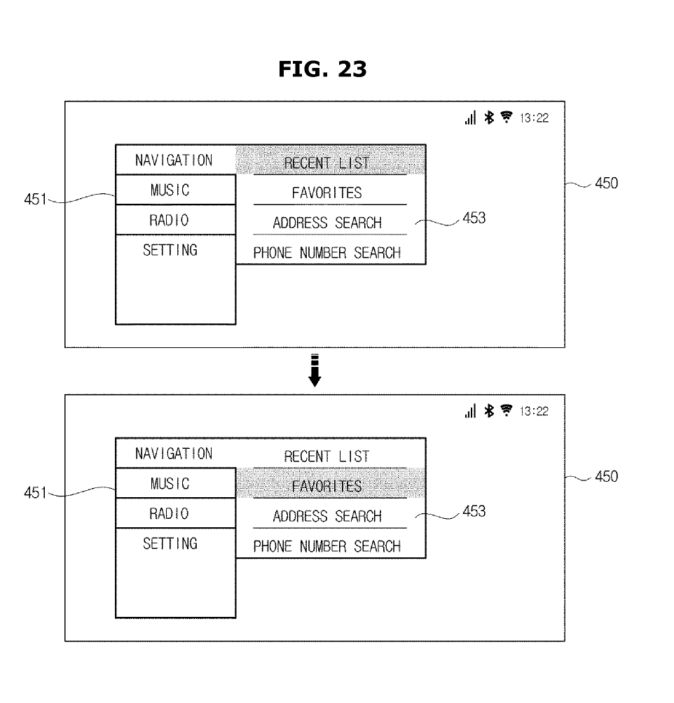

FIG. 22 is a view illustrating the variation of a menu selection screen by touching a first area and FIG. 23 is a view illustrating the variation of a menu selection screen by touching a second area. FIGS. 22 and 23 illustrate a menu selection screen 450, and in FIGS. 22 and 23, each menu may correspond to an above-mentioned item.

Referring to FIGS. 22 and 23, the menu selection screen displayed on the display unit 400 may include a top menu area 451 and a sub menu area 453. In the top menu area 451, a top menu, e.g., navigation, music, radio, and setting may be displayed, and in the sub menu area 453, a sub menu, e.g., recent list, favorites, address search, and phone number search, which correspond to the selected top menu, may be displayed. At this time, the sub menu displayed on the sub menu area 453 may be changed depending on the selected top menu.

The processor 300 may search a menu in response to the input of a rolling gesture of a user. Particularly, when a user inputs a rolling gesture to the first area 201, the processor 300 may adjust the selection of the top menu in response to the rolling gesture. For example, as illustrated in FIG. 12, when a rolling gesture is input to the first area 201, the selection of a top menu may be changed from “navigation” to “music”.

When the top menu is changed, a sub menu displayed on the sub menu display area 453 may be changed. For example, when the selected top menu is changed to “music”, “content list” corresponding to “music” may be displayed as a sub menu on the sub menu area 453.

Meanwhile, as illustrated in FIG. 13, when a user inputs a rolling gesture to the second area 202, the processor 300 may adjust the selection of the sub menu in response to a rolling gesture as illustrated in FIG. 23. That is, when a rolling gesture is input to the second area 202, the sub menu may be changed from “recent list” to “favorites”.

In other words, when an input position of a touch gesture is the first area 201 separated from the center (P), the selection of a top menu may be adjusted according to the input of a touch gesture, and when an input position of a touch gesture is the second area 202 including the center (P), the selection of a sub menu may be adjusted according to an input of a touch gesture.

The selected menu may be set to vary according to an input position of a touch gesture and thus the operational convenience of the user may be improved by reducing a depth to access a menu.

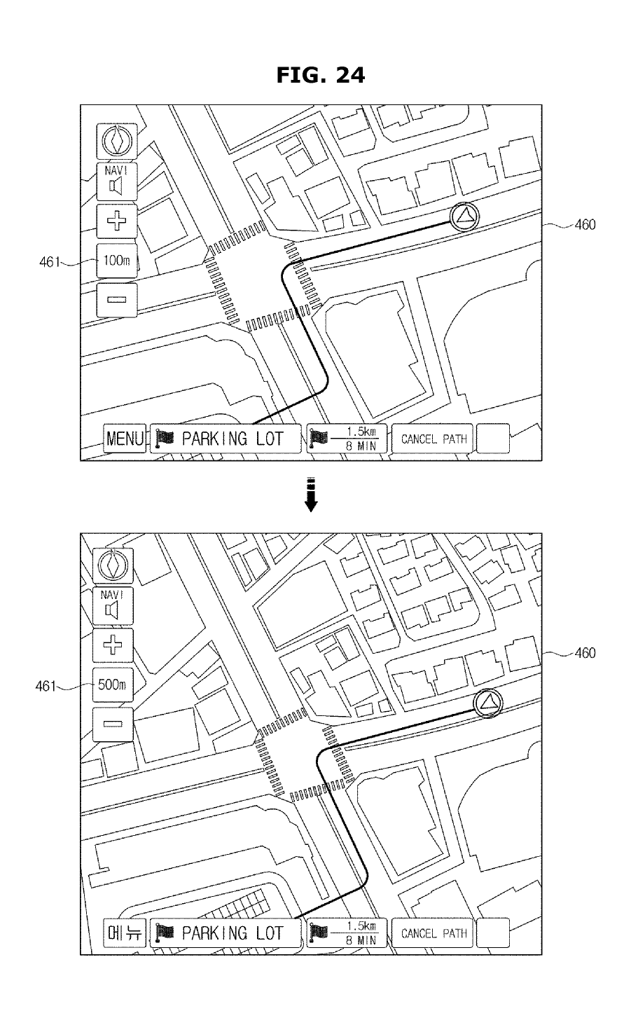

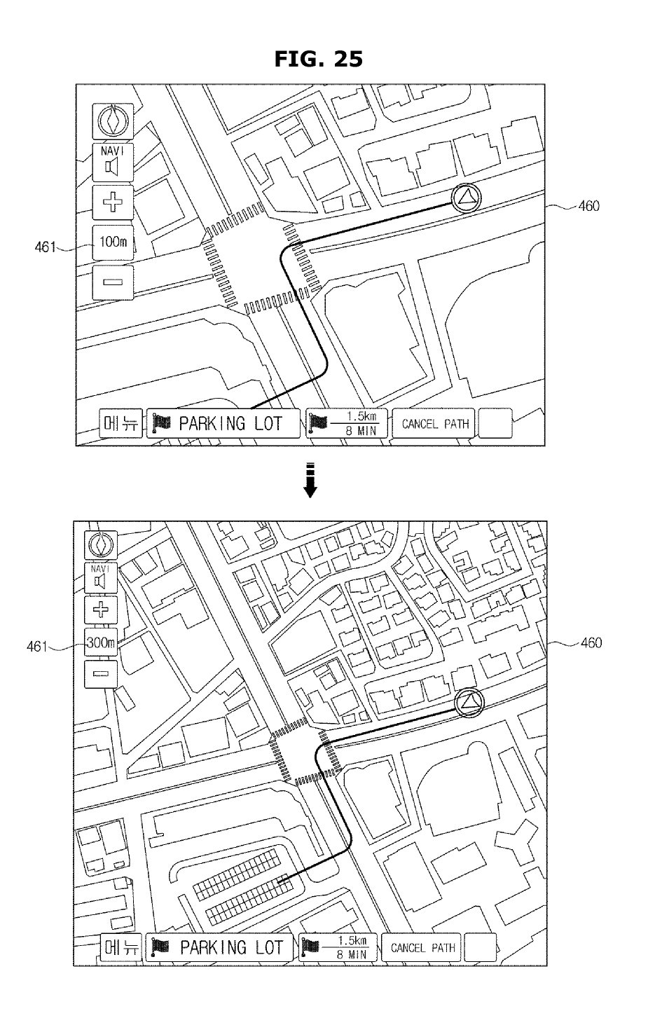

FIG. 24 is a view illustrating the variation of a navigation screen by touching a first area and FIG. 25 is a view illustrating the variation of a navigation screen by touching a second area. FIGS. 24 and 25 illustrate a navigation screen 460, and in FIGS. 24 and 25, a map may be an item. The navigation screen 460 may include a scale indicator 461 indicating a scale of a displayed map.

The processor 300 may change a scale of a map displayed on the navigation screen 460 in response to a user's gesture. The change of scale may be determined by the input direction of a rolling gesture. For example, when a rolling gesture is input clockwise, the scale may be increased, and when a rolling gesture is input counterclockwise, the scale may be reduced.

The range of the scale variation may vary according to the input position of a rolling gesture. That is, although the same rolling gesture is input, the range of the scale variation in a case of inputting in the first area 201, may be different from the range of the scale variation in a case of inputting in the second area 202. For example, when the input position of a rolling gesture is the first area 201, the scale may be increased from 100 to 500 as illustrated in FIG. 24, and when the input position of a rolling gesture is the second area 202, the scale may be increased from 100 to 300 as illustrated in FIG. 25.

That is, a user may accurately adjust the navigation scale by adjusting the input position of gesture.

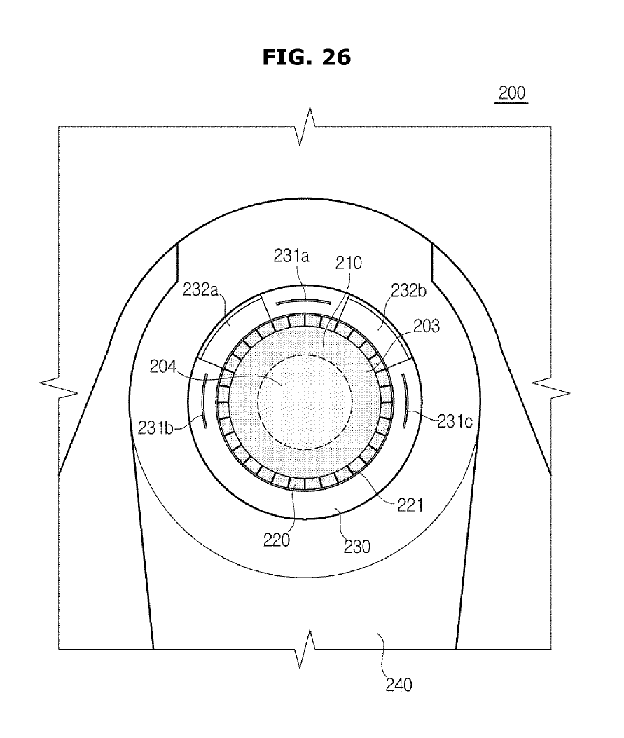

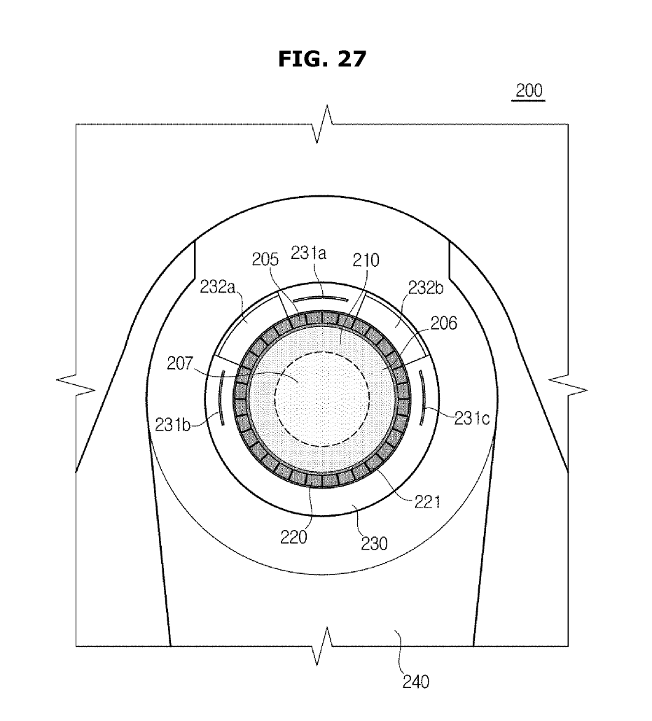

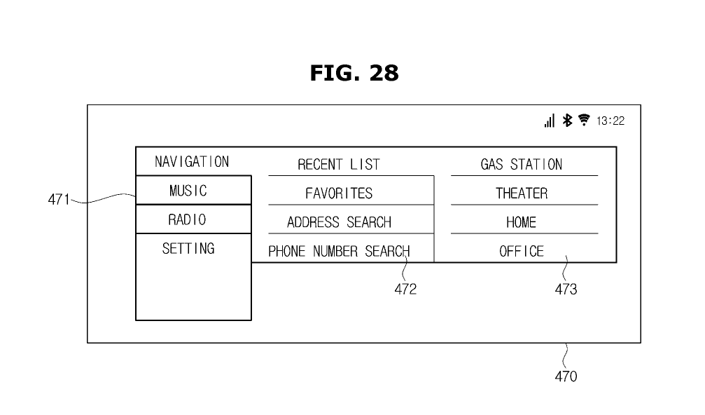

FIG. 26 is a view illustrating another example of a layout of a touch input device, FIG. 27 is a view illustrating another example of a layout of a touch input device and FIG. 28 is a view illustrating selecting a menu by using an input device of FIG. 27.

FIG. 11 illustrates that the second touch unit 220 is divided into two areas, but the layout of the input device is not limited thereto. Hereinafter a variety of layouts applicable to the input device will be described.

For example, the first area 201 and the second area 202 may be physically divided. That is, the second touch unit 220 may be the first area 201 and the first touch unit 210 may be the second area 202.

For another example, as illustrated in FIG. 26, the second touch unit 220 and an edge portion of the first touch unit 210 adjacent to the second touch unit 220 may be a first area 203, and the center of the first touch unit 210 may be a second area 204.

Meanwhile, FIG. 11 illustrates that the second touch unit 220 is divided into two areas but a touch area may be divided into more than two areas. For example, the touch area may be divided into three areas 205, 206 and 207, as illustrated in FIG. 28.

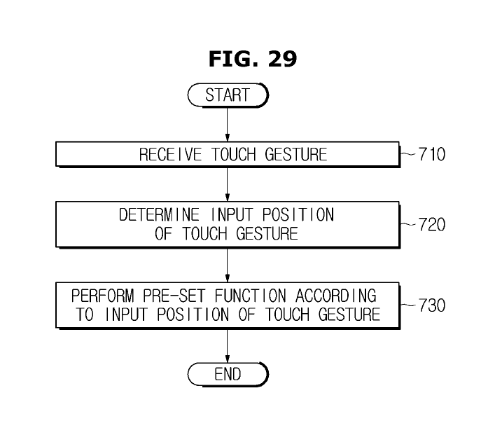

When the touch units 210 and 220 are divided into three areas 205, 206 and 207, for a single gesture, different function may be assigned for each area. Referring to FIGS. 28 and 29, a menu selection screen 470 may include a top menu area 471 displaying a top menu, a sub menu area 472 displaying a sub menu corresponding to the top menu, and a sub sub menu area 473 displaying a sub sub menu corresponding to the sub menu.

When a rolling gesture is input to the first area 205, the processor 300 may adjust the selection of the top menu displayed on the top menu area 471, when a rolling gesture is input to the second area 206, the processor 300 may adjust the selection of the sub menu displayed on the sub menu area 472, and when a rolling gesture is input to the third area 207, the processor 300 may adjust the selection of the sub sub menu displayed on the sub sub menu area 471

That is, as the input position of a touch gesture is moved to the center (P) of the touch area, the depth of the adjusted menu may be set to be deeper. The depth of the adjusted menu may be set to be deeper as the input position of touch gesture is moved to the center (P) of the touch area, so that a user may more intuitively select a menu, and a user may easily perform operations to access menu.

FIG. 29 is a flowchart illustrating a control method of a vehicle 1 in accordance with one embodiment of the present disclosure.

Referring to FIG. 29, the vehicle 1 may receive a touch gesture 710. The touch input device 200 may detect a touch from a user, and may output an electrical signal corresponding to the detected touch. The electrical signal output from the touch input device 200 may be input to the processor 300, and the processor 300 may recognize a gesture input by a user based on the electrical signal corresponding to the touch gesture.

The vehicle 1 may determine an input position of the touch gesture 720. The processor 300 may determine the input position of a received touch gesture by using any one of touch start coordinates, touch ending coordinates, and touch movement trajectories. Particularly, when the touch area is divided into two areas, as illustrated in FIG. 11, the processor 300 may determine whether the input position of touch gesture is the first area 201 or the second area 202.

The vehicle 1 may perform a pre-set function according to the input position of a touch gesture 730. The function performed by the vehicle 1 may be set to vary according to each area to which the touch gesture is input. For example, when the touch gesture is input to the first area 201, a first function may be performed, and when the touch gesture is input to the second area 202, a second function may be performed.

Further, as mentioned above, the first function and the second function may be set in a user interface which may be displayed when the touch gesture is input. Particularly, as illustrated in FIGS. 14 to 27, the function according to the input position of the touch gesture may be determined according to the user interface displayed on the display unit 400.

As is apparent from the above description, according to the proposed vehicle and the control method of the vehicle, an operation of convenience functions may be easily performed by a user by performing various functions according to an input position of a touch gesture.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A vehicle comprising:
a touch input device provided with a touch area to which a touch gesture is input; and
a processor for dividing the touch area into a first area and a second area, performing a first function when the touch gesture is input to the first area, and performing a second function, which is different from the first function, when the touch gesture is input to the second area.

2. The vehicle of claim 1 wherein
the processor sets an edge area of the touch area as the first area, and the center area of the touch area as the second area.

3. The vehicle of claim 1 wherein
the touch area is provided such that the center of the touch area is concave, and the processor divides the touch area into the first area and the second area by setting a virtual boundary line with respect to the center of the touch area.

4. The vehicle of claim 1 wherein
a curvature of the first area and a curvature of the second area are different from each other.

5. The vehicle of claim 1 wherein
the touch area comprises a first touch unit provided in a shape selected from the group consisting of an oval and a circular shape, and a second touch unit provided to be along a cylindrical surface of the first touch unit, wherein the processor sets the second touch unit as the first area, and the first touch unit as the second area.

6. The vehicle of claim 1 further comprising:
a display unit for displaying an term list,
wherein the processor performs a first function of scrolling an item list by a page unit when the touch gesture is input to the first area, and a second function of scrolling an item list by an item unit when the touch gesture is input to the second area.

7. The vehicle of claim 1 wherein
the processor determines the direction of scroll based on an input direction of the touch gesture, and determines the size of scroll based on the size of the touch gesture.

8. The vehicle of claim 1 further comprising:
a display unit configured to display a plurality of characters,
wherein the processor performs a first function, of selecting a character while moving by consonant unit, when the touch gesture is input to the first area, and performs a second function, of selecting character while moving by vowel unit, when the touch gesture is input to the second area.

9. The vehicle of claim 1 wherein
the display unit displays the plurality of characters to be arranged to correspond to the shape of the touch area.

10. The vehicle of claim 1 further comprising:
a display unit for displaying a radio channel control screen,
wherein the processor performs a first function, of changing a frequency to correspond to the touch gesture, when the touch gesture is input to the first area, and performs a second function, of changing a frequency by a pre-set frequency unit, when the touch gesture is input to the second area.

11. The vehicle of claim 1 further comprising:
a display unit provided with a top menu display area for displaying a top menu, and a sub menu display area for displaying a sub menu corresponding to the top menu,
wherein the processor performs a first function, of adjusting the selection of the top menu, when the touch gesture is input to the first area, and performs a second function, of adjusting the selection of the sub menu, when the touch gesture is input to the second area.

12. The vehicle of claim 10 wherein
the display unit changes a sub-menu, displayed on the sub menu display area, according to the change in the selection of the top menu, and displays the changed sub-menu.

13. The vehicle of claim 1 wherein
the first function is performed by a wheeling in the first area, and the second function is performed by a wheeling in the second area.

14. The vehicle of claim 1 further comprising:
a display unit for displaying a map,
wherein the processor performs a first function, of changing the scale according to a first reference, when the touch gesture is input to the first area, and performs a second function, of changing the scale according to a second reference different from the first reference, when the touch gesture is input to the second area.

15. The vehicle of claim 1 wherein
the touch gesture is a rolling gesture performed by drawing and touching a circular arc with respect to the center of the touch area.

16. A control method of a vehicle provided with a touch input device divided into a plurality of areas with respect to the center, comprising:
receiving an input of a touch gesture through the touch input device;
determining an area to which the touch gesture is input; and
performing a pre-set function according to an input area of the touch gesture.

17. The control method of claim 16 further comprising:
dividing a touch area into the plurality of areas by setting a virtual boundary line in the touch input device.

18. The control method of claim 17 wherein
the virtual boundary line is set with respect to the center of the touch area.

19. The control method of claim 18 further comprising:
displaying an item list,
wherein the step of performing a pre-set function according to an input area comprises determining a scroll unit of the item list according to the input area of touch gesture, and performing scrolling by the determined scroll unit.

20. The control method of claim 16 further comprising:
displaying a plurality of characters,
wherein the step of performing a pre-set function according to the input area comprises selecting characters by vowel unit when the input area of touch gesture is the center area, and selecting characters by consonant unit when the input area of touch gesture is the edge area.

21. The control method of claim 16 further comprising:
displaying a radio channel control screen,
wherein the step of performing a pre-set function according to an input area comprises changing a frequency to correspond to the touch gesture when the input area of touch gesture is the center area, and changing a frequency by a pre-set frequency unit when the input area of touch gesture is the edge area.

22. The control method of claim 16 further comprising:
displaying a top menu and a sub menu corresponding to the top menu,
wherein the step of performing a pre-set function according to an input area comprises adjusting the selection of the top menu when the input area of touch gesture is the edge area, and adjusting the selection of the sub menu when the input area of touch gesture is the center area.

23. The control method of claim 22 wherein
the step of performing a pre-set function according to an input area further comprises displaying a sub menu, which is changed to correspond to the changed top menu, when the selection of the top menu is changed.

24. The control method of claim 16 wherein
the step of determining an area to which the touch gesture is input comprises determining whether the touch gesture is input to the center area or the touch gesture is input to the edge area provided in an edge portion of the center area.
